(19) United States
(12) Patent Application Publication
(10) Pub. No.: US 2006/0160396 A1
(43) Pub. Date: Jul. 20, 2006

(54) Methods, systems and computer program products for notifying telecommunications system technicians of pending work orders

(75) Inventors: Daniel W. Macauley, Fishers, IN (US); Michael G. German, Secaucus, NJ (US); Matias Peluffo, Guadalajara (ES); Hester Tsui, Plano, TX (US)

Correspondence Address: MYERS BIGEL SIBLEY & SAJOVEC, PO BOX 37428, RALEIGH, NC, 27627, US

(73) Assignee: CommScope Solutions Properties, LLC

(21) Appl. No.: 11/312,943

(22) Filed: Dec. 20, 2005

Related U.S. Application Data
(60) Provisional application No. 60/637,699, filed on Dec. 21, 2004.

(51) Int. Cl. H01R 13/625

(52) U.S. Cl. 439/344

(57) ABSTRACT

Methods, systems and computer program products that notify technicians of work to be performed on a telecommunications system are provided. Interconnections with patch panel connector ports are monitored and a work order is generated in response to detecting the relocation of a patch cord connector at a patch panel. A technician automatically is notified that a work order has been generated. The technician is requested to acknowledge receipt of a work order notification. If an acknowledgement is not received within a predetermined period of time, an alternate technician is notified of the work order. A list of work orders are displayed on a display in communication with the telecommunications system. Displayed work orders can be filtered such that the a technician only views work orders he/she is authorized to view. A technician can select a displayed work order and retrieve additional information from a server managing the work orders.

### RELATED APPLICATION

This application claims the benefit of and priority to U.S. Provisional Patent Application No. 60/637,699 filed Dec. 21, 2004, the disclosure of which is incorporated herein by reference as if set forth in its entirety.

### FIELD OF THE INVENTION

The present invention relates generally to telecommunications systems and, more particularly, to telecommunications patching systems.

### BACKGROUND OF THE INVENTION

Many businesses have dedicated telecommunication systems that enable computers, telephones, facsimile machines and the like to communicate with each other through a private network, and to communicate with devices in remote locations via a telecommunications service provider. Conventionally, a dedicated telecommunications system is hard wired using telecommunication cables that contain conductive wire. In such hard wired systems, dedicated wires are coupled to individual service ports throughout a building, for example. The wires from the dedicated service ports conventionally extend throughout a building and into one or more telecommunications closets. The telecommunications lines from the interface hub of a main frame computer and the telecommunication lines from external telecommunication service providers may also terminate within a telecommunications closet.

A patching system is typically used to interconnect the various telecommunication lines within a telecommunications closet. In a conventional telecommunications patching system, the telecommunication lines are terminated within a telecommunications closet in an organized manner via one or more patch panels, as described below.

Referring to FIG. 1, a typical patch panel support rack 10 is shown. The rack 10 retains a plurality of patch panels 12 that are mounted to the rack 10. On each of the patch panels 12 are located port assemblies 14. The illustrated port assemblies 14 each contain six telecommunication connector ports 16 (e.g., RJ-45 ports). Other types of patch panels are known, including patch panels with optical fiber ports (e.g., SC, ST and LC ports) and 110 copper wire ports.

Each of the different telecommunication connector ports 16 is hard wired to a telecommunications line. Accordingly, each telecommunications line is terminated on a patch panel 12 in an organized manner. In small patch systems, all telecommunications lines may terminate on the patch panels of the same rack. In larger patch systems, multiple racks may be used, wherein different telecommunications lines terminate on different racks. Interconnections between the various telecommunications lines are made using patch cords 20. Both ends of a patch cord 20 are terminated with connectors 22, such as an RJ-45 or RJ-11 telecommunications connector. One end of a patch cord 20 is connected to a connector port 16 of a first telecommunications line and the opposite end of the patch cord 20 is connected to a connector port 16 of a second telecommunications line. By selectively connecting the various lines with patch cords 20, any combination of telecommunications lines can be interconnected.

In many businesses, employees are assigned their own computer network access number exchange so that the employee can interface with a main frame computer or computer network. When an employee changes office locations, it may not be desirable to provide that employee with new exchange numbers. Rather, to preserve consistency in communications, it may be preferred that the exchanges of the telecommunications ports in the employee's old office be transferred to the telecommunications ports in the employee's new office. To accomplish this task, patch cords in a telecommunication closet are rearranged so that the employee's old exchanges are now received in his/her new office.

As employees move, change positions, add or subtract lines, the patch cords in a typical telecommunications closet may require frequent rearrangement. Telecommunication patching systems that have the ability to sense a plug in a patch panel port or sense connection between two panel ports are referred to as intelligent patching systems. Intelligent patching systems are described in U.S. Pat. No. 6,222,908, which is incorporated herein by reference in its entirety.

When patch cords in a telecommunications closet are rearranged, a technician often is required after the fact to perform some work on the telecommunications system. As known to those skilled in the art of the present invention, technicians may be required to perform one or more of the following items (a non-exhaustive list): install cabling, install patch panels, make patching changes in a telecommunications closet, make changes in intermediate patching devices (e.g., consolidation points), install or move devices such as computers and/or phones, and troubleshoot connection problems, etc.

Unfortunately, no system exists that automatically alerts technicians of telecommunication patching system work that needs to be performed. The existing systems rely either on paper-based methods or intelligent patching systems. Paper-based methods may require a technician to consult a log book to see whether an IT administrator scheduled any work orders. Intelligent patching systems may require a technician to go directly to each telecommunications closet to retrieve electronic jobs for the equipment in the closet. In both of these arrangements, a technician has to gather information, which may be time consuming and costly.

### SUMMARY OF THE INVENTION

In view of the above discussion, methods, systems and computer program products that notify technicians of work to be performed on a telecommunications system are provided. A telecommunications system includes a patch panel having a plurality of connector ports, and a plurality of patch cords configured to selectively interconnect pairs of the connector ports.

Each patch cord has opposite ends and a respective connector secured to each end, and each connector is configured to be removably secured within a connector port. According to some embodiments of the present invention, patch cord interconnections with the patch panel connector ports are monitored and a work order is generated in response to detecting the relocation of a patch cord connector at the patch panel. The work order details, for example, work to be performed by a technician associated with the relocation of the patch cord connector. A technician automatically is notified that a work order has been generated.

According to some embodiments of the present invention, a technician is requested to acknowledge receipt of a work order notification. If an acknowledgement is not received within a predetermined period of time, an alternate technician is notified of the work order.

According to some embodiments of the present invention, a list of work orders and work order locations are displayed on a display in communication with the telecommunications system. Displayed work orders can be filtered such that a particular technician only views work orders he/she is authorized to view. According to some embodiments of the present invention, a technician can select a displayed work order and retrieve additional information from a server managing the work orders.

Embodiments of the present invention are advantageous because the efficiency of technicians performing work orders can be improved, thereby potentially resulting in increased cost savings. Also, embodiments of the present invention are advantageous because the content and timing of work orders and notifications can be user-configurable, resulting in a system that can be customized for the specific needs of an end-user.

### BRIEF DESCRIPTION OF THE DRAWINGS

FIG. 1 is a perspective view of a typical prior art telecommunications rack assembly containing multiple patch panels with connector ports that are selectively interconnected by patch cords.

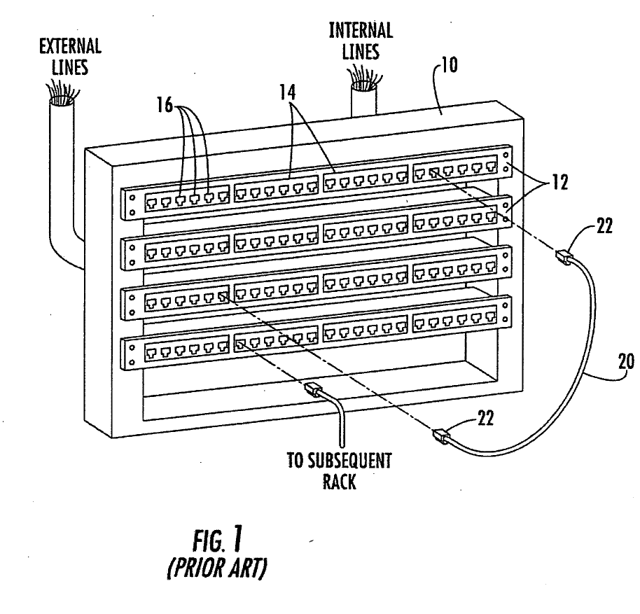

FIG. 2 is a flow chart of operations for automatically alerting technicians of telecommunications system work that needs to be performed, in accordance with some embodiments of the present invention.

FIG. 3 is a block diagram that illustrates a software architecture for automatically alerting technicians of telecommunications system work that needs to be performed, in accordance with some embodiments of the present invention.

### DETAILED DESCRIPTION OF THE INVENTION

The present invention now will be described more fully hereinafter with reference to the accompanying drawings, in which illustrated embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first patch panel port could be termed a second patch panel port, and, similarly, a second patch panel port could be termed a first patch panel port without departing from the teachings of the disclosure.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and devices in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computing device (such as a computer or other programmable data processing apparatus) to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

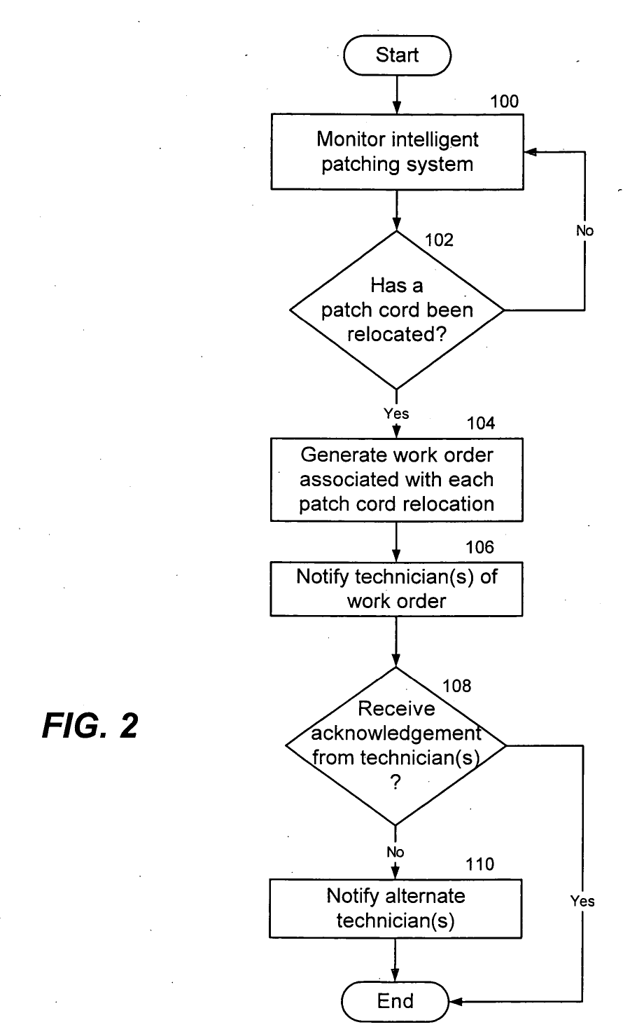

The flowchart of FIG. 2 illustrates the architecture, functionality, and operations of some embodiments of methods, systems, and computer program products for automatically alerting technicians of work that needs to be performed on a telecommunications system as a result of patch cord relocations in a telecommunications closet. In this regard, each block in the flow chart represents a module, segment, or portion of code, which comprises one or more executable instructions for implementing the specified logical function(s). It should also be noted that in other implementations, the function(s) noted in the blocks may occur out of the order described with respect to FIG. 2.

According to embodiments of the present invention, the patch system of a telecommunications system is monitored for the relocation of one or more patch cords (Block 100). If a patch cord relocation is detected (Block 102), a work order is generated (Block 104). A work order is a list of activities to connect one or more devices to a telecommunication/data network. Activities include, but are not limited to, installing network equipment, installing patch panels, installing outlets, cabling outlets to panels, adding/removing/moving patch cords, adding/removing/moving devices such as computers and phones, making changes to a telecommunication/data network on passive connecting hardware (e.g., 110 connecting hardware, consolidation points, panels, etc.).

A technician or technician group is notified upon the generation of a work order (Block 106). Notification may be accomplished in any of various ways. For example, an electronic message can be transmitted to a technician via cell phone, pager, wrist watch, PDA, computer, etc. Notification can be immediately upon generation of a work order or can be performed subsequent in time. According to some embodiments of the present invention, time and content of notifications can be configured to the specific needs of a technician or technician group. Moreover, work orders can be compiled for a particular technician or technician group and notification can be made when a predetermined number of work orders have accumulated.

According to embodiments of the present invention, a technician or technician group is requested to acknowledge receipt of a work order notification. If an acknowledgement is not received within a predetermined period of time (Block 108) an alternate technician or technician group is notified of the work order (Block 110).

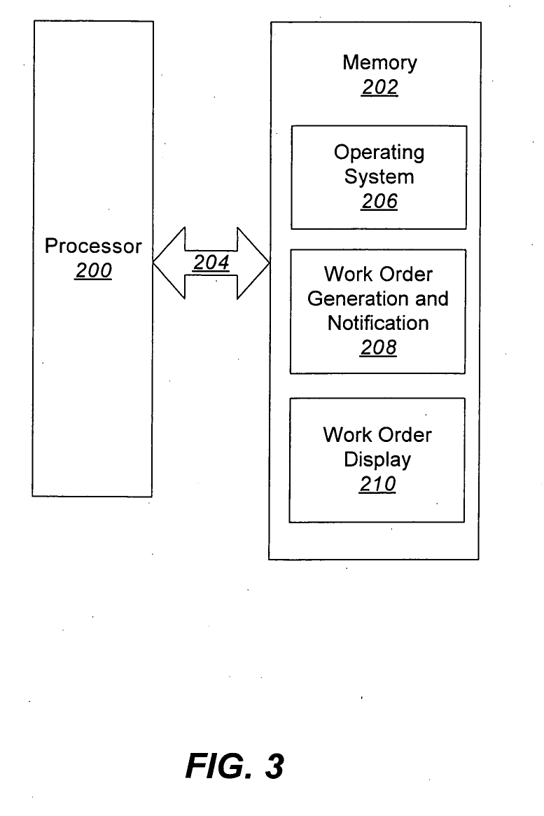

FIG. 3 illustrates a processor 200 and a memory 202 hosted by a telecommunications system device or controller that may be used in embodiments of methods, systems, and computer program products for automatically alerting technicians of work that needs to be performed on a telecommunications system. For example, in some embodiments of the present invention, the processor 200 and memory 202 may be used to embody the processors and the memories used in generating work orders and notifying a technician or group of technicians of existing work orders. The processor 200 communicates with the memory 202 via an address/data bus 204. The processor 200 may be, for example, a commercially available or custom microprocessor. The memory 202 is representative of the overall hierarchy of memory devices containing the software and data used to generate work orders and notify a technician or group of technicians of existing work orders, in accordance with some embodiments of the present invention. The memory 202 may include, but is not limited to, the following types of devices: cache, ROM, PROM, EPROM, EEPROM, flash, SRAM, and DRAM.

As shown in FIG. 3, the memory 202 may hold three or more major categories of software and data: an operating system 206, a work order generation and notification module 208, and a work order display module 210. The operating system 206 controls operations of the telecommunications system host device. In particular, the operating system 206 may manage the host device's resources and may coordinate execution of programs by the processor 200. The work order generation and notification module 208 comprises logic for monitoring the patch system of a telecommunications system and detecting when patch cords are relocated. The work order generation and notification module 208 comprises logic for generating work orders and notifying a technician or technician group upon the generation of a work order. The work order generation and notification module 208 comprises logic for configuring notification time and content to the specific needs of a technician or technician group, and for compiling work orders for a particular technician or technician group. The work order generation and notification module 208 comprises logic for receiving acknowledgement of receipt of work order notification and for notifying alternate technicians or technician groups if an acknowledgement is not received within a predetermined period of time.

According to some embodiments of the present invention, the work order generation and notification module 208 comprises logic for allowing an administrator to create work orders and automatically alert the appropriate technician or technician group based on the type or location of work to be performed.

The work order display module 210 comprises logic for displaying a list of work orders and the work order locations (e.g., the location where a patch cord relocation has occurred, etc.) on a display connected to an intelligent patching system of a telecommunications system. In addition, the work order display module 210 comprises logic for limiting or filtering which work orders can be viewed by a particular technician or technician group. The work order display module 210 comprises logic for allowing a technician or technician group to retrieve additional information from a server managing the work orders, and logic for limiting access and type of information to be displayed, based on the technician or technician group. According to some embodiments of the present invention, the work order display module 210 comprises logic that allows features to be customized to a specific technician or groups of technicians. To aide technicians in managing their activities, this feature allows a technician (or group of technicians) to view only his/her active work orders. This list changes as a technician completes his/her activities. According to some embodiments of the present invention, completed activities are removed from the list and new activities are added after some of the early activities are completed or when new activities are created by the person who is responsible for scheduling the work.

Although FIG. 3 illustrates an exemplary software architecture that may facilitate alerting technicians of work that needs to be performed on a telecommunications system as a result of patch cord relocations in a telecommunications closet, it will be understood that the present invention is not limited to such a configuration but is intended to encompass any configuration capable of carrying out the operations described herein. Embodiments of the present invention can be integrated into management software utilized by intelligent patching systems.

Computer program code for carrying out operations of devices and/or controllers discussed above with respect to FIG. 3 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Many variations and modifications can be made to the preferred embodiments without substantially departing from the principles of the present invention. All such variations and modifications are intended to be included herein within the scope of the present invention, as set forth in the following claims.

That which is claimed is:

1. A method of notifying technicians of work to be performed on a telecommunications system, wherein the telecommunications system includes a patch panel having a plurality of connector ports, and a plurality of patch cords configured to selectively interconnect pairs of the connector ports, wherein each patch cord has opposite ends and a respective connector secured to each end, wherein each connector is configured to be removably secured within a connector port, the method comprising:
monitoring patch cord interconnections with the connector ports;
generating a work order in response to detecting relocation of a patch cord connector at the patch panel, wherein the work order details work to be performed by a technician associated with the relocation of the patch cord connector; and
automatically notifying a technician that a work order has been generated.

2. The method of claim 1, further comprising requesting acknowledgment from a technician that a work order notification was received.

3. The method of claim 2, further comprising notifying an alternate technician that a work order has been generated if an acknowledgment of a previously sent work order notification has not been received within a predetermined period of time.

4. The method of claim 1, further comprising displaying a list of work orders and work order locations on a display in communication with the telecommunications system.

5. The method of claim 4, wherein displaying a list of work orders and work order locations on a display comprises filtering work orders and work order locations according to technician.

6. The method of claim 4, further comprising displaying additional information about a work order in response to user selection of the work order via the display.

7. A telecommunications system, comprising:
a patch panel comprising a plurality of connector ports;
a plurality of patch cords configured to selectively interconnect pairs of the connector ports, wherein each patch cord comprises opposite ends and a respective connector secured to each end, wherein each connector is configured to be removably secured within a connector port;
means for monitoring patch cord interconnections with the connector ports;
means for generating a work order in response to detecting relocation of a patch cord connector at the patch panel, wherein the work order details work to be performed by a technician associated with the relocation of the patch cord connector; and
means for automatically notifying a technician that a work order has been generated.

8. The telecommunications system of claim 7, further comprising means for requesting acknowledgment from a technician that a work order notification was received.

9. The telecommunications system of claim 8, further comprising means for notifying an alternate technician that a work order has been generated if an acknowledgment of a previously sent work order notification has not been received within a predetermined period of time.

10. The telecommunications system of claim 7, further comprising:
means for generating a work order independently of relocation of a patch cord connector at the patch panel, wherein the work order details work to be performed by a technician on the telecommunications system; and
means for automatically notifying a technician that a work order has been generated.

11. The telecommunications system of claim 7, further comprising means for displaying a list of work orders and work order locations on a display in communication with the telecommunications system.

12. The telecommunications system of claim 11, further comprising means for filtering work orders and work order locations according to technician.

13. The telecommunications system of claim 11, further comprising means for displaying additional information about a work order in response to user selection of the work order via the display.

14. The telecommunications system of claim 7, wherein the means for automatically notifying a technician that a work order has been generated comprises means for sending an electronic message to the technician.

15. A computer program product for notifying technicians of work to be performed or a telecommunications system, wherein the telecommunications system includes a patch panel having a plurality of connector ports, and a plurality of patch cords configured to selectively interconnect pairs of the connector ports, wherein each patch cord has opposite ends and a respective connector secured to each end, wherein each connector is configured to be removably secured within a connector port, the computer program product comprising a computer usable storage medium having computer readable program code embodied in the medium, the computer readable program code comprising:
computer readable program code that monitors patch cord interconnections with the connector ports;
computer readable program code that generates a work order in response to detecting relocation of a patch cord connector at the patch panel, wherein the work order details work to be performed by a technician associated with the relocation of the patch cord connector; and
computer readable program code that automatically notifies a technician that a work order has been generated.

16. The computer program product of claim 15, further comprising computer readable program code that requests acknowledgment from a technician that a work order notification was received.

17. The computer program product of claim 16, further comprising computer readable program code that notifies an alternate technician that a work order has been generated if an acknowledgment of a previously sent work order notification has not been received within a predetermined period of time.

18. The computer program product of claim 15, further comprising:
computer readable program code that generates a work order independently of relocation of a patch cord connector at the patch panel, wherein the work order details work to be performed by a technician on the telecommunications system; and
computer readable program code that automatically notifies a technician that a work order has been generated.

19. The computer program product of claim 15, further comprising computer readable program code that displays a list of work orders and work order locations on a display in communication with the telecommunications system.

20. The computer program product of claim 19, further comprising computer readable program code that filters work orders and work order locations according to technician.

21. The computer program product of claim 19, further comprising computer readable program code that displays additional information about a work order in response to user selection of the work order via the display.

22. The computer program product of claim 15, wherein the computer readable program code that automatically notifies a technician that a work order has been generated comprises computer readable program code that sends an electronic message to the technician.
